(19) United States
(12) Patent Application Publication
(10) Pub. No.: US 2009/0319721 A1
(43) Pub. Date: Dec. 24, 2009

(54) FLASH MEMORY APPARATUS AND METHOD FOR OPERATING THE SAME

(75) Inventor: Tsai-Cheng Lin, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: SILICON MOTION, INC., Hsinchu County (TW)

(21) Appl. No.: 12/395,736

(22) Filed: Mar. 2, 2009

Related U.S. Application Data
(60) Provisional application No. 61/073,784, filed on Jun. 19, 2008.

(30) Foreign Application Priority Data
Oct. 16, 2008 (TW) 97139710

(51) Int. Cl. G06F 12/02; G06F 12/00

(52) U.S. Cl. 711/103; 711/E12.001; 711/E12.008

(57) ABSTRACT

The invention provides a method for operating a flash memory apparatus. In one embodiment, the flash memory apparatus comprises a single-level-cell memory and a multiple-level-cell memory. First, new data for updating a logical block address is received from a host. An update count corresponding to the logical block address is then compared with a threshold value. When the update count is greater than the threshold value, it is determined whether a first physical block address corresponding to the logical block address is pointing to a multiple-level-cell block of the multiple-level-cell memory. When the first physical block address is pointing to the multiple-level-cell block, a target single-level-cell block is then selected from the single-level-cell memory. A corresponding relationship between the logical block address and a second physical block address of the target single-level-cell block is then built. The new data is then written to the target single-level-cell block with the second physical block address.

### CROSS REFERENCE TO RELATED APPLICATIONS

This application claims the benefit of U.S. Provisional Application No. 61/073,784, filed on Jun. 19, 2008, the entirety of which is incorporated by reference herein.

This Application claims priority of Taiwan Patent Application No. 97139710, filed on Oct. 16, 2008, the entirety of which is incorporated by reference herein.

### BACKGROUND OF THE INVENTION

1. Field of the Invention

The invention relates to flash memories, and more particularly to writing data to flash memories.

2. Description of the Related Art

Presently available flash memories are divided into two categories. One category is referred to as single-level-cell (SLC) flash memories, and the other category is referred to as multiple-level-cell (MLC) flash memories. A single-level-cell flash memory comprises a plurality of blocks, wherein each of the blocks comprises a plurality of memory cells, and each of the memory cells only stores one-bit data. A multiple-level-cell flash memory also comprises a plurality of blocks, wherein each of the blocks comprises a plurality of memory cells, and each of the memory cells stores data of multiple bits.

Because memory cells of a single-level-cell memory store only one-bit data, a single-level-cell memory has a smaller data capacity than that of a multiple-level-cell memory. A single-level-cell memory, however, has a faster access speed and a higher endurable writing frequency than those of a multiple-level-cell memory. The single-level-cell memory and the multiple-level-cell memory therefore have different advantages suitable for different applications, and a system can determine which of a single-level-cell memory and a multiple-level-cell memory is chosen for data storage according to an application style thereof to improve performance of the system.

A conventional flash memory apparatus comprises only one of a single-level-cell memory and a multiple-level-cell memory. If a flash memory apparatus comprises both a single-level-cell memory and a multiple-level-cell memory, the flash memory apparatus can provide both advantages of the single-level-cell memory and the multiple-level-cell memory, such as large data capacity, fast access speed, and high endurable writing frequency. The flash memory apparatus comprising both a single-level-cell memory and a multiple-level-cell memory, however, is more complex and difficulty arises when accessing the two kinds of flash memories with different properties. Meanwhile, because the single-level-cell memory and the multiple-level-cell memory have different properties, the flash memory apparatus is required to determine whether data is stored in the single-level-cell memory or the multiple-level-cell memory according to the properties thereof. A method for operating a flash memory apparatus comprising both a single-level-cell memory and a multiple-level-cell memory is therefore provided.

### BRIEF SUMMARY OF THE INVENTION

The invention provides a method for operating a flash memory apparatus. In one embodiment, the flash memory apparatus comprises a single-level-cell memory and a multiple-level-cell memory. First, new data for updating a logical block address is received from a host. An update count corresponding to the logical block address is then compared with a threshold value. When the update count is greater than the threshold value, it is determined whether a first physical block address corresponding to the logical block address is pointing to a multiple-level-cell block of the multiple-level-cell memory. When the first physical block address is pointing to the multiple-level-cell block, a target single-level-cell block is then selected from the single-level-cell memory. A corresponding relationship between the logical block address and a second physical block address of the target single-level-cell block is then built. The new data is then written to the target single-level-cell block with the second physical block address.

The invention provides a flash memory apparatus. In one embodiment, the flash memory apparatus comprises a single-level-cell memory, a multiple-level-cell memory, and a controller. The single-level-cell memory comprises a plurality of single-level-cell blocks. The multiple-level-cell memory comprises a plurality of multiple-level-cell blocks. The controller receives new data for updating a logical block address from a host, compares an update count corresponding to the logical block address with a threshold value, determines whether a first physical block address corresponding to the logical block address is pointing to a multiple-level-cell block of the multiple-level-cell memory when the update count is greater than the threshold value, selects a target single-level-cell block from the single-level-cell memory when the first physical block address is pointing to the multiple-level-cell block, establishes a corresponding relationship between the logical block address and a second physical block address of the target single-level-cell block, and writes the new data to the target single-level-cell block with the second physical block address.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a flash memory apparatus according to the invention;

FIG. 2 shows a corresponding relationship between logical block addresses and physical block addresses according to the invention;

FIG. 3 is a flowchart of a method for operating a flash memory apparatus according to the invention;

FIG. 4 is a schematic diagram of a first stage of an embodiment of operations of a flash memory apparatus according to the invention;

FIG. 5 is a schematic diagram of a second stage of the embodiment of operations of the flash memory apparatus according to the invention; and

FIG. 6 is a schematic diagram of a third stage of the embodiment of operations of the flash memory apparatus according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

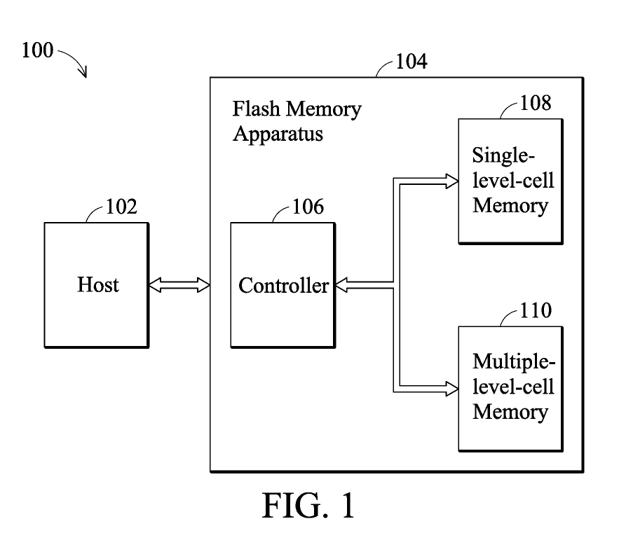

Referring to FIG. 1, a block diagram of a flash memory apparatus 104 according to the invention is shown. In one embodiment, the flash memory apparatus 104 is a memory card or a solid state disk. The flash memory apparatus 104 stores data for a host 102. In one embodiment, the flash memory apparatus 104 comprises a controller 106, a single-level-cell memory 108, and a multiple-level-cell memory 110. The single-level-cell memory 108 comprises a plurality of single-level-cell blocks, and each of the single-level-cell blocks comprises a plurality of single-level cells storing one-bit data. The multiple-level-cell memory 110 comprises a plurality of multiple-level-cell blocks, and each of the multiple-level-cell blocks comprises a plurality of multiple-level cells storing multiple bits of data. The controller 106 is coupled between the host 102, the single-level-cell memory 108, and the multiple-level-cell memory 110. The controller 106 writes data received from the host 102 to the single-level-cell memory 108 or the multiple-level-cell memory 110 according to instructions of the host 102, or reads data from the single-level-cell memory 108 or the multiple-level-cell memory 110 and then delivers the read-out data to the host 102.

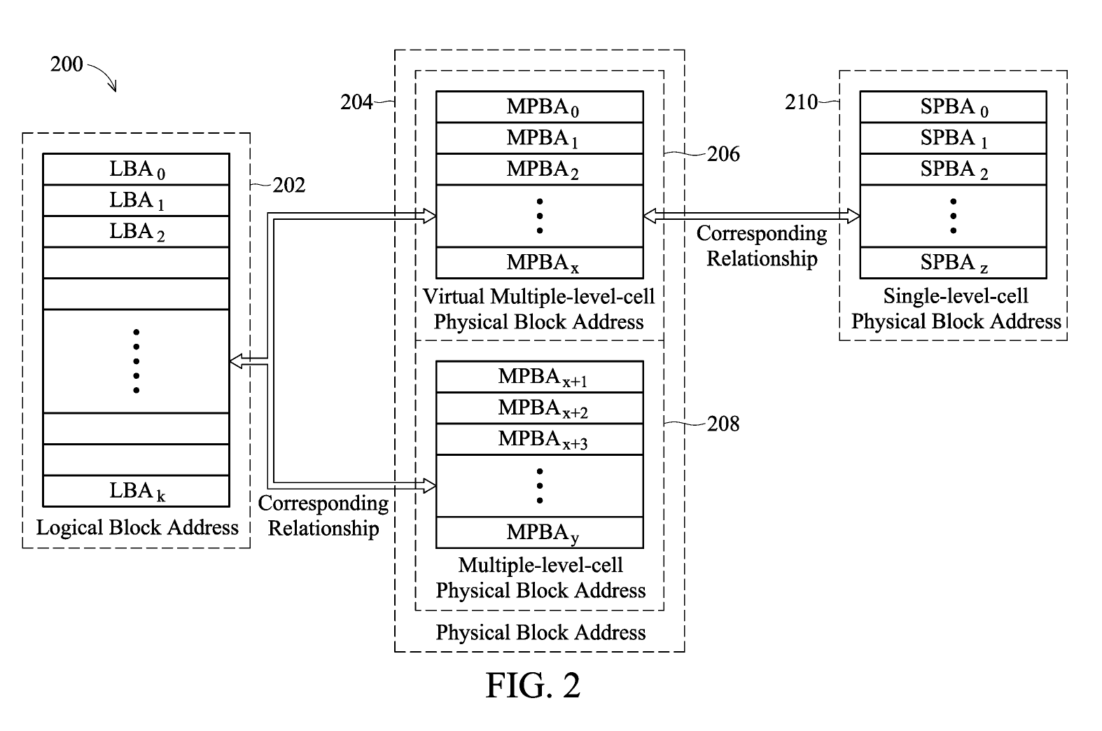

Referring to FIG. 2, a corresponding relationship between logical addresses and physical addresses according to the invention is shown. The host 102 accesses data from the flash memory apparatus 104 according to logical block addresses 202. The single-level-cell memory 108 accesses data stored therein according to physical block addresses 210. The multiple-level-cell memory 110 accesses data stored therein according to physical block addresses 208. Because the controller 110 is an intermediary between the host 102, the single-level-cell memory 108, and the multiple-level-cell memory 110, the controller 110 must converts a logical block address 202 sent from the host 102 to a physical block address 208 of the multiple-level-cell memory 110 or a physical block address 210 of the single-level-cell memory 108 before the single-level-cell memory 108 or the multiple-level-cell memory 110 is accessed.

In addition, two series of physical block addresses, comprising the physical block addresses 210 of the multiple-level-cell memory 110 and the physical block addresses 208 of the single-level-cell memory 108, coexist in the flash memory apparatus 104, thus complicating addressing in data accessing. For simplicity, the physical block addresses 210 of the single-level-cell memory 108 are virtually combined with the physical block addresses 208 of the multiple-level-cell memory 110 to form a series of virtual physical block addresses 204. In one embodiment, the controller 106 converts the physical block addresses 210 of the single-level-cell memory 108 to virtual physical block address 206 with the same format with the physical block addresses 208 of the multiple-level-cell memory 110, and the physical block addresses 208 of the multiple-level-cell memory 110 are the virtual physical block addresses 208 of the multiple-level-cell memory 110 without conversion.

For example, the physical block addresses SPBA₀˜SPBA_{z} of the single-level-cell memory 108 are converted to virtual physical block address MPBA₀˜MPBAₓ with the same format with the physical block addresses MPBAₓ₋₁˜MPBA_{y} of the multiple-level-cell memory 110. In addition, the virtual physical block addresses MPBA₀˜MPBAₓ of the single-level-cell memory 108 have prior address sequence in the series, and the virtual physical block addresses MPBAₓ₊₁˜MPBA_{y} of the multiple-level-cell memory 110 have subsequent sequence in the series. In one embodiment, the controller 106 records corresponding relationships between all logical block addresses LBA₀˜LBAₖ and all virtual physical block addresses MPBA₀˜MPBA_{y} in an address link table. In another embodiment, the controller 106 also stores a corresponding relationship between the virtual physical block addresses MPBA₀˜MPBAₓ and the physical block addresses SPBA₀˜SPBA_{z} of the single-level-cell memory 108 in an address conversion table.

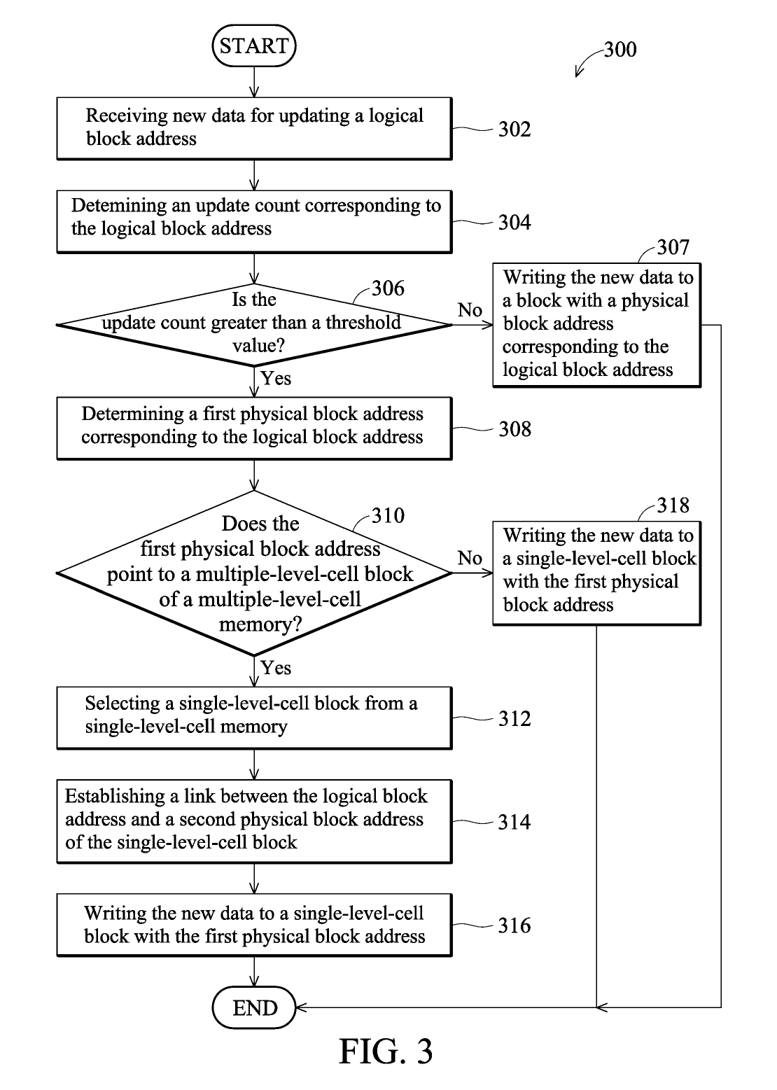

Referring to FIG. 3, a flowchart of a method 300 for operating a flash memory apparatus according to the invention is shown. First, the controller 106 receives new data for updating a logical block address from the host 102 (step 302). The controller 106 then determines an update count corresponding to the logical block address (step 304). The update count records a frequency in which data with the logical block address has been updated. In one embodiment, the controller 106 records update counts of all logical block addresses used by the host 102 in an update count table. Whenever the host 102 requests the controller 106 to write data to a logical block address, the controller 102 modify the update count table by incrementing an update count corresponding to the logical block address by one. The controller 106 therefore can look up the update count in the update count table according to the logical block address in step 304.

When the update count corresponding to the logical block address is greater than a threshold value (step 306), the logical block address to be updated has a high update frequency, and a block of the single-level-memory 108 is suitable for holding data with the logical block address. The controller 106 then determines a first physical block address corresponding to the logical block address (step 308), and then determines whether the first physical block address is pointing to a multiple-level-cell block of the multiple-level-cell memory 110 (step 310). In one embodiment, an address link table of the controller 106 records corresponding relationships between all logical block addresses and physical block addresses, and the controller 106 can look up the first physical block address in the address link table according to the logical block address in step 308. Because the physical block addresses 204 of the single-level-cell memory 108 has a prior sequence and the physical block addresses 208 of the multiple-level-cell memory 110 has a subsequent sequence as shown in FIG. 2, the controller 106 can therefore determine whether the first physical block address is pointing to a multiple-level-cell block of a multiple-level-cell memory according to the first physical block address in step 310.

Because the single-level-cell memory 108 has a faster access speed and a higher endurable writing frequency than the multiple-level-cell memory 110, data with a high update count is suitable to be stored in the single-level-cell memory 108. If the first physical block address is pointing to a multiple-level-cell block of the multiple-level-cell memory 110 in step 310, the controller 106 stores the new data with a high update count in the single-level-cell memory 108 instead of the multiple-level-cell memory 110. The controller 106 therefore selects a single-level-cell block from the single-level-cell memory 108 (step 312), establishes a corresponding relationship between the logical block address of the new data and a second physical block address of the single-level-cell block (step 314), and then writes the new data to the single-level-cell block with the second physical block address (step 316). In one embodiment, an address link table of the controller 106 records corresponding relationships between all logical block addresses and physical block addresses, and the controller 106 modifies the address link table according to the logical block address and the second physical block address to establish the corresponding relationship therebetween in step 314.

The controller 106 can select a target single-level-cell block for storing the new data from the single-level-cell memory 108 in a variety of ways in step 312. In one embodiment, the controller 106 first determines update counts of a plurality of single-level-cell blocks of the single-level-cell memory 108, and then selects a single-level-cell block with a smallest update count from the plurality of single-level-cell blocks as the target single-level-cell block. In another embodiment, the controller 106 first determines update counts of a plurality of single-level-cell blocks of the single-level-cell memory 108, and then selects a single-level-cell block with an update count smaller than a threshold number from the plurality of single-level-cell blocks as the target single-level-cell block.

After the controller 106 selects the target single-level-cell block for storing the new data in step 312, the controller 106 must further determine whether old data has been stored in the target single-level-cell block. If so, the controller 106 has to make a backup copy of the old data before the new data is written to the target single-level-cell block in step 316. After the new data is written to the target single-level-cell block in step 316, the controller 106 then modifies the address link table to establish a corresponding relationship between a logical block address previously corresponding to the target single-level-cell block and the first physical block address of the multiple-level-cell block. The controller 106 then writes the old data to the multiple-level-cell block with the first physical block address. The old data previously stored in the target single-level-cell block is finally stored in the multiple-level-cell block, and the new data formerly determined to be stored in the multiple-level-cell block is finally stored in the target single-level-cell block, completing data exchange between the target single-level-cell block and the multiple-level-cell block.

In addition, because the single-level-cell memory 108 is suitable for storing data with a high update count, when the update count corresponding to the logical block address is not greater than the threshold value in step 306, the controller 106 does not differentiate whether a block corresponding to the logical block address belongs to the single-level-cell memory 108 or the multiple-level-cell memory 110 in steps 308 and 310, and directly writes the new data to the block corresponding to the logical block address (step 307). Accordingly, when the first physical block address is pointing to a single-level-cell block of the single-level-cell memory 108 in step 310, the controller 106 directly writes the new data to the single-level-cell block with the first physical block address in step 318 without further performing the steps 312˜316.

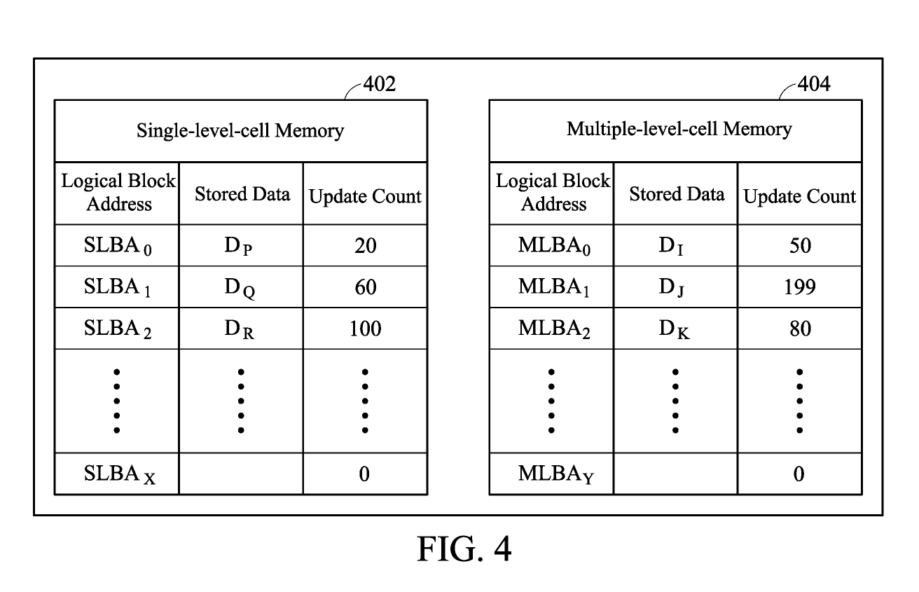

Referring to FIG. 4, a schematic diagram of a first stage of an embodiment of operations of a flash memory apparatus according to the invention is shown. The flash memory apparatus comprises a single-level-cell memory 402 and a multiple-level-cell memory 404. The single-level-cell memory 402 comprises X single-level-cell blocks respectively corresponding to logical block addresses SLBA₀˜SLBA_{X}. The single-level-cell block corresponding to the logical block address SLBA₀ stores data D_{P} and has an update count of 20. The single-level-cell block corresponding to the logical block address SLBA₁ stores data D_{Q} and has an update count of 60. The single-level-cell block corresponding to the logical block address SLBA₂ stores data D_{R} and has an update count of 100. The single-level-cell block corresponding to the logical block address SLBA_{X} stores no data and has an update count of 0.

The multiple-level-cell memory 404 comprises Y multiple-level-cell blocks respectively corresponding to logical block addresses MLBA₀˜MLBA_{Y}. The multiple-level-cell block corresponding to the logical block address MLBA₀ stores data D_{I} and has an update count of 50. The multiple-level-cell block corresponding to the logical block address MLBA₁ stores data D_{J} and has an update count of 199. The multiple-level-cell block corresponding to the logical block address MLBA₂ stores data D_{K} and has an update count of 80. The multiple-level-cell block corresponding to the logical block address MLBA_{Y} stores no data and has an update count of 0.

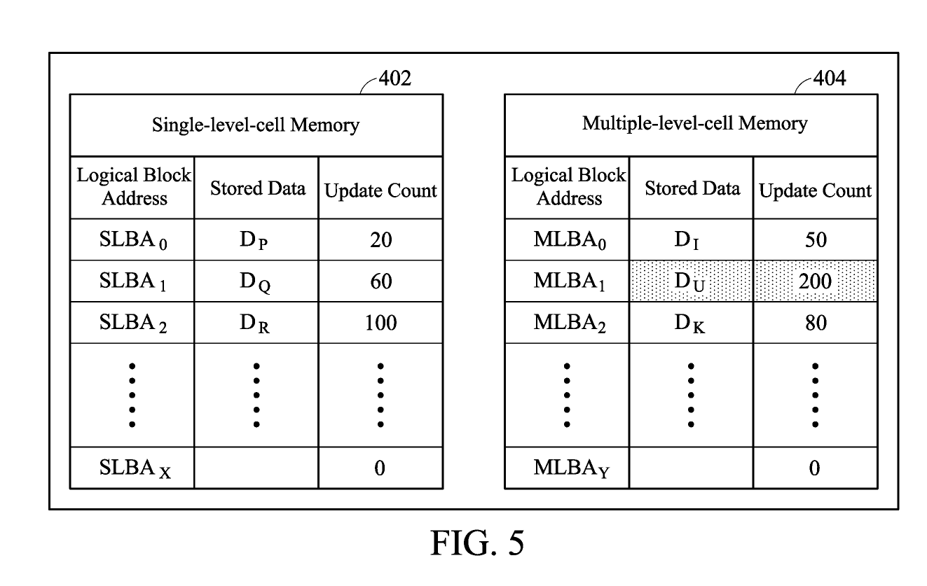

Referring to FIG. 5, a schematic diagram of a second stage of the embodiment of operations of the flash memory apparatus according to the invention is shown. When a host requests the flash memory apparatus to write new data D_{U} to the multiple-level-cell block corresponding to the logical block address MLBA₁, a controller of the flash memory apparatus then stores the new data D_{U} in the multiple-level-cell block corresponding to the logical block address MLBA₁, and the update count corresponding to the logical block address MLBA₁ is increased by one to be 200. The update count 200 of the original multiple-level-cell block corresponding to the logical block address MLBA₁, however, is equal to a threshold value 200, and the controller therefore selects a target single-level-cell block for storing the new data D_{U} in substitution for the original multiple-level-cell block from the single-level-cell memory 402. Because the single-level-cell block corresponding to the logical block address SLBA_{X} has a smallest update count of 0, the controller selects the single-level-cell block corresponding to the logical block address SLBA_{X} as the target single-level-cell block.

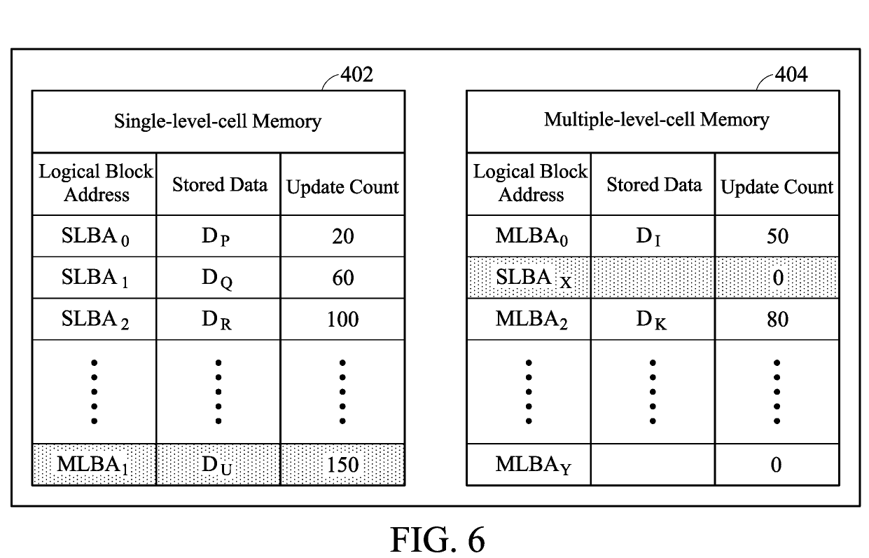

Referring to FIG. 6, a schematic diagram of a third stage of the embodiment of operations of the flash memory apparatus according to the invention is shown. The controller changes the logical block address of the target single-level-cell block from SLBA_{X} to MLBA₁, and then stores the new data D_{U} to the target single-level-cell block. In addition, instead of changing the update count of the target single-level-cell block from 0 to 200, the controller also changes the update count of the target single-level-cell block from 0 to 150, thus making the update count of the target single-level-cell block to be less than the threshold value 200. The controller then changes the logical block address of the original multiple-level-cell block from MLBA₁ to SLBA_{X}, and then clears data stored in the original multiple-level-cell block. In addition, the controller also changes the update count of the original multiple-level-cell block from 200 to 0. Data exchange between the original multiple-level-cell block and the target single-level-cell block is thus completed.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for operating a flash memory apparatus, wherein the flash memory apparatus comprises a single-level-cell memory and a multiple-level-cell memory, comprising:
receiving new data for updating a logical block address from a host;
comparing an update count corresponding to the logical block address with a threshold value;
when the update count is greater than the threshold value, determining whether a first physical block address corresponding to the logical block address is pointing to a multiple-level-cell block of the multiple-level-cell memory;
when the first physical block address is pointing to the multiple-level-cell block, selecting a target single-level-cell block from the single-level-cell memory;
establishing a corresponding relationship between the logical block address and a second physical block address of the target single-level-cell block; and
writing the new data to the target single-level-cell block with the second physical block address.

2. The method as claimed in claim 1, wherein the method further comprises, when the update count is not greater than the threshold value, writing the new data to a block with a physical block address corresponding to the logical block address.

3. The method as claimed in claim 1, wherein the method further comprises, when the first physical block address is pointing to a single-level-cell block of the single-level-cell memory, writing the new data to the single-level-cell block with the first physical block address.

4. The method as claimed in claim 1, wherein selection of the target single-level-cell block comprises:
determining update counts of a plurality of single-level-cell blocks of the single-level-cell memory; and
selecting a single-level-cell block with a smallest update count from the plurality of single-level-cell blocks as the target single-level-cell block.

5. The method as claimed in claim 1, wherein selection of the target single-level-cell block further comprises:
determining update counts of a plurality of single-level-cell blocks of the single-level-cell memory; and
selecting a single-level-cell block with an update count smaller than a threshold number from the plurality of single-level-cell blocks as the target single-level-cell block.

6. The method as claimed in claim 1, wherein the method further comprises:
after the target single-level-cell block is selected, determining whether the target single-level-cell block stores old data;
when the target single-level-cell block stores old data, making a backup copy of the old data before the new data is written to the target single-level-cell block;
establishing a corresponding relationship between a logical block address previously corresponding to the target single-level-cell block and the first physical block address of the multiple-level-cell block; and
writing the old data to the multiple-level-cell block with the first physical block address.

7. The method as claimed in claim 1, wherein the flash memory apparatus comprises an update count table for recording update counts of all logical block addresses used by the host, and comparison of the update count comprises searching the update count table for the update count according to the logical block address.

8. The method as claimed in claim 1, wherein the flash memory apparatus comprises an address link table for recording corresponding relationships between all logical block addresses used by the host and physical block addresses, and establishing of the corresponding relationship comprises modifying the address link table according to the logical block address and the second physical block address.

9. The method as claimed in claim 1, wherein the flash memory apparatus has a series of physical block addresses, and single-level-cell blocks of the single-level-cell memory have physical block addresses with prior sequence in the series, and multiple-level-cell blocks of the multiple-level-cell memory have physical block addresses with subsequent sequence in the series.

10. The method as claimed in claim 9, wherein determination of whether the first physical block address is pointing to the multiple-level-cell block comprises determining whether the first physical block address has a subsequent sequence in the series.

11. A flash memory apparatus, comprising:
a single-level-cell memory, comprising a plurality of single-level-cell blocks;
a multiple-level-cell memory, comprising a plurality of multiple-level-cell blocks;
a controller, receiving new data for updating a logical block address from a host, comparing an update count corresponding to the logical block address with a threshold value, determining whether a first physical block address corresponding to the logical block address is pointing to a multiple-level-cell block of the multiple-level-cell memory when the update count is greater than the threshold value, selecting a target single-level-cell block from the single-level-cell memory when the first physical block address is pointing to the multiple-level-cell block, establishing a corresponding relationship between the logical block address and a second physical block address of the target single-level-cell block, and writing the new data to the target single-level-cell block with the second physical block address.

12. The flash memory apparatus as claimed in claim 11, wherein when the update count is not greater than the threshold value, the controller writes the new data to a block with a physical block address corresponding to the logical block address.

13. The flash memory apparatus as claimed in claim 11, wherein when the first physical block address is pointing to a single-level-cell block of the single-level-cell memory, the controller writes the new data to the single-level-cell block with the first physical block address.

14. The flash memory apparatus as claimed in claim 11, wherein the controller determines update counts of a plurality of single-level-cell blocks of the single-level-cell memory, and selects a single-level-cell block with a smallest update count from the plurality of single-level-cell blocks as the target single-level-cell block.

15. The flash memory apparatus as claimed in claim 11, wherein the controller determines update counts of the plurality of single-level-cell blocks of the single-level-cell memory, and selects a single-level-cell block with an update count smaller than a threshold number from the plurality of single-level-cell blocks as the target single-level-cell block.

16. The flash memory apparatus as claimed in claim 11, wherein after the target single-level-cell block is selected, the controller determines whether the target single-level-cell block stores old data, makes a backup copy of the old data before the new data is written to the target single-level-cell block when the target single-level-cell block stores old data, establishes a corresponding relationship between a logical block address previously corresponding to the target single-level-cell block and the first physical block address of the multiple-level-cell block, and writes the old data to the multiple-level-cell block with the first physical block address.

17. The flash memory apparatus as claimed in claim 11, wherein the controller comprises an update count table for recording update counts of all logical block addresses used by the host, and the controller searches the update count table for the update count according to the logical block address for comparison of the update count and the threshold value.

18. The flash memory apparatus as claimed in claim 11, wherein the controller comprises an address link table for recording corresponding relationships between all logical block addresses used by the host and physical block addresses, and the controller modifies the address link table according to the logical block address and the second physical block address to establishes the corresponding relationship between the logical block address and the second physical block address.

19. The flash memory apparatus as claimed in claim 11, wherein the flash memory apparatus has a series of physical block addresses, and single-level-cell blocks of the single-level-cell memory have physical block addresses with prior sequence in the series, and multiple-level-cell blocks of the multiple-level-cell memory have physical block addresses with subsequent sequence in the series.

20. The flash memory apparatus as claimed in claim 19, wherein the controller determines whether the first physical block address has a subsequent sequence in the series to determine whether the first physical block address is pointing to the multiple-level-cell block.
